(19) United States
(12) Patent Application Publication
(10) Pub. No.: US 2024/0373100 A1
(43) Pub. Date: Nov. 7, 2024

(54) SMART CHANNEL SURFING OF LINEAR TV

(71) Applicant: Adeia Guides Inc., San Jose, CA (US)

(72) Inventors: Ning Xu, Irvine, CA (US); Tao Chen, Palo Alto, CA (US); Kyle Beckemeyer, Park Ridge, IL (US); Reda Harb, Tampa, FL (US)

(21) Appl. No.: 18/653,273

(22) Filed: May 2, 2024

Related U.S. Application Data
(60) Provisional application No. 63/463,544, filed on May 2, 2023.

(51) Int. Cl. H04N 21/475; H04N 21/431

(52) U.S. Cl. CPC H04N 21/4755; H04N 21/4316

(57) ABSTRACT

The disclosed systems and methods enable a queue-based real-time navigation of linear television channels using a two button “channel backtrack” (or, e.g., “channel down”) and “next channel” (or, e.g., “channel up”) approach. Rather than tedious surfing of a static channel lineup, the systems and methods utilize two dynamic queues: a history queue tracks recently visited channels and a future queue is loaded with recommended channels based on personalized rankings. Using these two queues, and an input interface for a “channel backtrack” command and a “next channel” command, the disclosed techniques provide users an alternative to typical channel surfing experiences. The queue of future channels can be dynamically updated based on updated rankings and recommendations.

### RELATED APPLICATIONS

This application claims the benefit of U.S. Provisional Application No. 63/463,544, filed May 2, 2023, the entire contents of which are hereby incorporated by reference herein.

### BACKGROUND

The present disclosure relates to systems and methods for navigating provided content, and more particularly to systems and related processes for navigating linear television and streaming channels with dynamically updated queues of recent channel history and recommended future channels to visit.

### SUMMARY

Content may be consumed on a plurality of channels that may be delivered via cable, antenna, satellite, Internet Protocol, streaming, and more. For instance, traditional television channels typically delivered via airwaves or cable may be also delivered via streaming platforms. Such traditional linear channels may appear next to premium channels, online-only programming, user-generated streams, and free ad-supported streaming television (FAST) channels to give viewers thousands of (or more) channels via various platforms and/or sources. In some approaches to a linear TV experience, a user interface may allow manual browsing available content via an electronic program guide (EPG) or “flip through” channels to find desirable programming. More specifically, in a typical linear TV example, an interface may be tuned to a current numerical channel (e.g., channel 10) and receive, via a remote control, a “channel up” command that increments the channel to a next higher numerical channel after the current channel (e.g., channel 11) or a “channel down” command that decrements the channel to a next lower numerical channel below the current channel (e.g., channel 9). Such “channel surfing” experiences can be tedious with large amounts of channels and/or slow buffering times, particularly if the user does not know exactly what channels and/or programs may be available. Conducting a search or browsing an EPG is ineffective for a quick channel change during a boring portion, repetitive sequence, and/or a commercial break. Groups and lists of “favorite” channels ignore program changes on each channel over time and may limit the number of channels cycled through. Typical recommendation engines designed for on-demand content and/or short-form videos also fail to consider start and end times of linear TV programming. If a viewer fails to efficiently find desirable content at a given time on a platform, the platform may fail to retain viewers. Without viewers and/or a consistent way for viewers to find desired channel(s), channel sources and content publishers may leave platforms. There exists a need for a channel surfing interface that both facilitates dynamic channel recommendations and enables channel backtracking. More specifically, there exists a need for a two-command scheme in linear TV for navigating channel queues in a non-sequential manner such that the system can easily switch to channels having the highest-matched recommendation for content while also allowing the viewer to easily go back through previously viewed channels and programming.

Devices can facilitate delivery of content for consumption via various platforms. Content such as video, animation, radio, music, audiobooks, ebooks, advertisements, playlists, podcasts, images, slideshows, games, text, and other media may be consumed by users at any time, as well as nearly in any place. While a significant amount of content may be available on demand, some content may be delivered live (or pre-recorded and played live), e.g., via channels from cable, antenna, satellite, IP, streaming, and more. Channels that are supported with advertisements have grown in popularity as alternatives (or supplements) to subscription-based content delivery (e.g., cable, IPTV, over-the-top programming, etc.). Devices, such as computers, telephones, smartphones, tablets, smartwatches, speakers/microphones (e.g., with a virtual assistant), activity trackers, e-readers, voice-controlled devices, servers, televisions, digital content systems, video game consoles, and other internet-enabled appliances can provide and deliver content almost instantly. Platforms may carry broadcast channels, premium channels, online-only programming, user-generated streams, FAST channels, pay-per-view channels, radio, and more channels to various connected devices.

Linear TV platforms are offering more and more channels. As of 2016, adults in the U.S. receive 206 television channels on average. Among those channels, less than 10 percent are being watched every month. FAST channels are growing quickly, and an astonishing 1,400 plus channels are already available for watching for free and supported by advertisements. The average daily time spent with video content among adults in the United States was about 5 hours in 2022—about half of those hours are spent on TV and another half on other digital video devices. Moreover, OTT services continue to attract more subscribers, which are predicted to total about 2 billion subscribers in 2023. There is simply too much content for viewers to find and consume.

Content delivery systems may use, for example, interactive content guidance applications to facilitate content consumption, as well as track a history of content items consumed over time and recommend content for future consumption. A content history, for instance, may include a list of all content consumed. For example, the content history may indicate a content item consumed by, e.g., a title or unique identifier associated with the content item. If desired, the content history may indicate other information associated with the consumed content item. For example, the content history may indicate a date or time the content item was consumed, a delivery channel by which the content item was consumed (e.g., a linear TV channel, a streaming channel, a URL, etc.), or an amount of time consumed (e.g., indicated by a unit of time or percentage). A content history may be identified by other names, including a “viewing history” for video programs consumed, a “listening history” for radio, audiobooks, podcasts, playlists or other audio content consumed, and/or a “browsing history.” Content history may also be called “viewing activity,” “watch history,” “video history,” or other designations to identify previously consumed programs and/or profile data. Typically, a viewing history is associated with a profile or an account such as a user profile, user account, subscriber profile, or subscriber account. As used herein, “subscriber” may be used as an equivalent to user, user account, viewer, viewer account, or other account with content provider systems and/or services. A viewing history may be stored as part of a user profile and may be referred to as a subscriber profile. A user may be considered a subscriber without paying a fee to a service or platform, e.g., only using ad-supported content delivery. Some services may require a user to sign up while others may generate a profile based on access data like IP address or other associated usernames/profiles. With services such as some video-on-demand systems, where purchase or renting of content may be required, a viewing history may be stored as or with a purchase history or rental history. A viewing history may be stored on a device and be associated with one or multiple users. A viewing history may be stored locally or in the cloud (e.g., a remote secure server) and accessed by interactive content guidance applications initiated by a subscriber (e.g., subscriber log-in).

When navigating channels and programs, a recorded log of such activity may be recorded, e.g., as part of a viewing history. For instance, “channel surfing” activities where the channel is changed from one to another in search of desirable content may be logged based on, e.g., the channel viewed, the associated time, and the programming on the channel during that time. In some cases, input and/or remote-control button presses may be logged as data describing how the channel changed, which could be valuable. For instance, a direct dial (or voice request) to channel number 927 may signify a viewer is familiar with and/or prefers that channel (e.g., at the particular time or generally). Switching back to one program after viewing two or more may indicate a preferred program. Channel changes after significant time scrolling in an EPG may indicate a preference over various other programs available at the time. Accessing program descriptions or hovering may indicate potential interest and/or indecision regarding content.

Generally, when a user is watching linear TV, channel up and channel down switches the channel according to a predefined channel lineup. Assuming there are M channels in the channel lineup, and the user is currently in channel n (n=1, . . . , M), if the user presses channel up button, the TV switches to channel (n MOD M)+1. If the user presses channel down button, the TV switches to channel ((n−2) MOD M)+1. For instance, a viewer may be watching the Star TV channel and may press a button for the next channel, and, according to the lineup of movie channels, the channel “Sony Max” displays, no matter what is showing on Sony Max—despite the program shown on “Movies Now” channel being the most attractive to the user at the time.

Current content recommendation and personalization features are not particularly suited for the dynamic environment of linear TV. For instance, current approaches of content recommendation favor on-demand content over linear TV channels. OTT platforms, for instance, may suggest movies and TV shows that match a viewer's profile, but such content is always available to start at any time, and often a different set of content may be available on linear TV channels, which may only be available temporarily.

Some approaches may utilize personalized channel lineups. For instance, with a large variety of live streaming channels in a live TV channel guide, a viewer may wish to hide certain channels, create a custom list of her favorites, or filter the guide to only show certain channels. Such approaches may essentially hide or delete channels with programming that, at certain times, may be desirable to the viewer. There exists a need to dynamically rank channels based on the content showing at the moment or to be shown shortly in the future, not merely group or hide channels in a channel lineup.

Moreover, approaches that use only favorite channels are too limited. In a platform with hundreds or thousands of channels, a list of favorites may be several dozen channels. Surfing through 20-plus channels may take too long to find desirable programming. Additionally, ignoring hundreds (or thousands) of other channels is unsustainable for the channel providers and the platform. Approaches that allow grouping of favorites (e.g., sports, comedy, premium, etc.) are also unsatisfactory for a platform carrying hundreds of channels, e.g., that may rarely or never get accessed. Such channel interface approaches access channels while ignorant of the programming on each channel at any given moment.

Some approaches for recommending content may use personalized ranking and recommendations to surf videos like with short-form video platforms such as YouTube Shorts and TikTok. Generally, linear TV has different characteristics from short video platforms in that, e.g., its content is pre-programmed, time-sensitive, and usually in a long video format. Recommending a channel in linear TV is more complicated than automatically queueing a short-form video using current personalized ranking and recommendation algorithms. For instance, channels in linear TV show different programs at different times and, if a user typically prefers channel A to channel B, at a specific time when the platform receives a command to surf from channel C to a different channel, the viewer might instead prefer watching the program coming up on channel B to the program showing on channel A.

An approach of treating each individual program in linear TV as an on-demand asset or short video in the personalized ranking and recommendation algorithm is not tenable either, due to the various start and end times of linear TV programming. Traditional cable and broadcast platforms certainly have programs of various lengths, starting at different times, and FAST has even more programs starting at times other than the top and bottom of each hour. For example, suppose a viewer prefers program A1 in channel A to program B1 in channel B, at a specific time when both program A1 and program B1 are shown. In that case, it is still not necessarily a good idea to recommend channel A over channel B, as at the specific time when the user wants to surf to a new channel, program A1 might be almost at the end while program B1 might just be starting. This is one of the primary differences between linear TV and short video platforms, as programs in linear TV may not be restarted, at the time of switch, from the beginning, e.g., as short videos automatically are, typically. There exists a need for a personalized ranking and recommendation algorithm for surfing channels in linear TV.

Another key difference of linear TV from short-form videos that makes short-form video recommendation algorithms inapplicable is that linear TV is programmed ahead of time, so when surfing on linear TV, only a personalized ranking and recommendation algorithm can consider the future program to be shown on each channel. Based on the previous example, since program A1 is almost ending, normally a personalized ranking and recommendation algorithm may recommend program B1 to the user, but if the next-up program A2 in channel A may be available shortly and is much more attractive to the user than program B1 then a personalized ranking and recommendation algorithm for linear TV may also take this into account and recommend/tune to channel A rather than B.

At the same time, such a personalized ranking and recommendation algorithm may also consider the video's time sensitivity and the user's time sensitivity. Some types of videos, like movies, might be very time-sensitive, as normally the user may not want to start watching a movie from the middle, while some other types of videos are less sensitive to time. Moreover, some users may tolerate watching movies from the middle, while others would rather wait for an extended period to start watching from the beginning. This kind of issue is not addressed with, e.g., recommendation algorithms used for short-form videos.

While the total number of channels in linear TV can be overwhelmingly large, the number of linear TV channels may be significantly less than the total number of videos (or short videos) on a given video platform. Accordingly, a ranking and recommendation algorithm based on suggesting a video (or a short-form video) may also differ when considering the scale and efficiency.

One approach may include, for example, an interface that predicts shows that a viewer is going to watch based on what a viewer usually watches at a particular time or day. Such an approach, however, focuses on content rather than channels. For example, such an approach may recommend “The Late Show” and “Late Night” rather than CBS or NBC. Moreover, such an approach is dependent upon a particular program appearing on the schedule at the same time each day (or week) and doesn't account for reruns at different times and on different channels. Generally, such an approach is not suitable for ranking channels and/or enabling channel surfing.

Other approaches using personalized recommendation methods including, e.g., collaborative filtering, content-based filtering, hybrid recommender systems, and deep-learning-based methods are similarly unfit for linear TV in their current form. Collaborative filtering typically uses past user interactions, e.g., likes, views, to recommend videos to similar users. Content-based filtering typically recommends videos based on the attributes of the video (e.g., title, tags, description) and the user's past interactions. Hybrid Recommender Systems typically are combinations of collaborative filtering and content-based filtering which are used to make more accurate recommendations by considering both the attributes of the video and the user's past interactions. Deep-learning-based methods typically utilize deep-learning models to learn patterns in user and video data to make recommendations. These methods typically only deal with common user-item relationships, e.g., where the item is not changing over time like the aired TV programs. There exists a need to address time-critical, dynamic recommendations and rankings in linear TV.

Described herein are various approaches for a channel surfing experience for linear TV that utilizes a personalized ranking and recommendation algorithm(s). In some embodiments, the algorithm considers the local time stamps of the TV programs. In some embodiments, the algorithm considers the video sensitivity of time as well as the user sensitivity of time. In some embodiments, the algorithm considers both the programs that are shown on each channel and also the next-up programs to be shown on each channel.

In some embodiments, a system may maintain in memory two dynamic queues. One queue may be called a Dynamic History Channel Queue (DHCQ), which dynamically holds indicators for the recently browsed channels so the user can surf channels back and forth. The other queue may be called a Dynamic Future Channel Queue (DFCQ), which holds references for the ranked channels of all the other channels that are not in the DHCQ. In some embodiments, the DHCQ is different from the video surfing history in traditional linear TV platforms or a short-form video platform, as the DHCQ may be updated dynamically, for example, at a time when the channel in the DHCQ starts a new program. Similarly, the DFCQ is different from the channel lineup in linear TV as it is dynamically updated based on personalized ranking scores.

In some embodiments, a history queue includes indicators (e.g., references, pointers, URLs, URIs, etc.) for channel A, channel B, and channel C (indicating that the current channel is channel C). If the user interface receives input of a “channel backtrack” command, the current channel becomes channel B. At this moment, the most recently viewed channel is channel B, which is not at the top of the history queue. The history queue still contains channels A, B, and C in this exact order. In such an embodiment, the “next channel” command may take the user back “up” the queue to channel C (e.g., rather than selecting the next best option from the future queue). In such a case, the history queue may be refreshed after a time threshold (e.g., moving channel B to the top of the queue, and tracking that the “current channel” again corresponds to the top of the history queue).

In some embodiments, a history queue instantly updates after a “channel backtrack” command is received and processed. For example, the history queue may include indicators for channel A, channel B, and channel C (indicating that the current channel is channel C). If the user inputs a “channel backtrack” command, the current channel becomes channel B. At this moment, the most recently viewed channel is channel B. In this embodiment, the history queue may be refreshed to have an order of A, C, and then B (wherein the current channel, B, is moved to the top of the history queue).

In some embodiments, either or both queues are updated based on any one or more triggers. A first trigger may be a detected change in content items now available at one or more channels. This may be gleaned from electronic programming guide information, for example. A second trigger may be a time-out, which may cause a re-ranking of channels based on content (and other factors, if desired) after a period has passed. This period may be static (e.g., every half hour) or dynamic (e.g., based on an analysis of expected end-times for currently available content items).

In some embodiments, any suitable input may signal “channel backtrack” or “next channel.” For example, the user may interact with the system via audio commands or gestures. In some instances, the system may automatically navigate to a “next channel” by detecting disinterest from the user (e.g., based on an analysis of body language, facial expressions, gaze, etc.). Some embodiments may use input from, e.g., remote control, touchscreen, mouse, trackball, keypad, keyboard, joystick, voice recognition interface, or other user input interfaces.

Some embodiments may utilize a channel surfing engine, e.g., as part of an interactive content guidance application. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In some embodiments, for instance, a channel surfing engine may determine a history queue (e.g., DHCQ) indicating a first one or more channels, from a plurality of channels, determined to have been recently viewed, the history queue ordered in a manner that accounts for recency. The channel surfing engine may determine personalized ranking scores for a plurality of channels, including (i) detecting content items available on the plurality of channels, (ii) scoring the content items based on a personalized ranking algorithm, and (iii) determining the personalized ranking scores based on the scoring of the content items.

In some embodiments, the channel surfing engine may determine a future queue (e.g., a DHFQ) indicating a second one or more channels, from the plurality of channels, other than the first one or more channels, that are ordered according to the personalized ranking scores for the content available on the second one or more channels.

In some embodiments, the channel surfing engine may detect a “next channel” command and, in response, dynamically update the history and future queues, including (i) changing the current channel to a given channel at the top of the future queue; and (ii) moving the given channel from the future queue to the top of the history queue in response to changing the current channel.

In some embodiments, the channel surfing engine may monitor content available on channels in a history queue and dynamically update the history and future queues accordingly, including, e.g., (i) moving a particular channel from the history queue to the future queue in response to determining that the particular channel is now showing different content than it was when the user last viewed the particular channel and (ii) dynamically updating the ordering of the future queue according to a personalized ranking score of the content now available on the particular channel and according to personalized ranking scores of content available on the other channels in the future queue.

In some embodiments, the channel surfing engine may monitor content available on channels in the future queue and dynamically update the future queue accordingly, including, e.g., (i) dynamically updating the personalized ranking scores according to currently available content on the channels and (ii) regularly updating the order of the future queue according to the updated personalized ranking scores.

Other embodiments of these aspects include corresponding computer systems, apparatus, and computer programs recorded on one or more computer storage devices, each configured to perform the actions of the methods.

In some embodiments, a set-top box accesses a channel/frequency table mapping channels to frequencies. In the U.S., a TV channel is a 6 MHz wide chunk of band space. For example, the bottom edge of channel 2 is 54 MHz, and the upper edge is 60 MHz. For a box to receive channel 2, it needs to know a radio frequency corresponding to channel 2 (e.g., 54 MHz-60 MHz). In a typical example, the box receives a command to receive channel 2. The box then references a table mapping the channel (e.g., 2) to a specific aspect of RF band, such as the lower edge frequency (e.g., 54 MHz) of the RF band.

In some embodiments, the queues store channel IDs (e.g., channel numbers). When a “next channel” command is received, the box references the future queue to determine the “top” channel (e.g., 56) in the queue. The box then references the channel/frequency table to extract the frequency corresponding to the top channel in the future queue, and it tunes to the extracted frequency.

In some embodiments, the system scores channels based, at least in part, on an analysis of content the user is currently viewing and/or the length of time the user has watched the content. In short, the longer a user is viewing a content item, the stronger this signals a user's interest in a characteristic of the content item. For example, if the user stops for an extended period on a channel showing an NBA game, this may signal an interest in sports, basketball, the NBA, or the team(s) playing in the game. As it becomes apparent that the user is staying on this channel, any one or more of these potential interests may be weighted higher or “boosted” when analyzing the user's current interests. Subsequently, the future queue may be rescored to account for the updates to the user's current interests.

In some embodiments, the ranking scores for a top number of channels may fall below a threshold delta. For example, if the channels are scored on a scale of 0-100, the top three channels in the future queue may have scores falling within five points of each other. In such a scenario, the system may prompt the user to select from these three channels. For example, a picture-in-picture (PiP) mosaic may be displayed, wherein each of the pictures is selectable as a command to show larger (e.g., full screen).

In some embodiments, the user may be presented with selectable buttons or other graphical representations of the channels. The user's selection may be accounted for in future selections to improve channel scoring.

In some embodiments, the user may simply be notified, after changing to the next channel, that one or more other channels have similar scores (or that a significant gap exists between the score of the just-loaded channel and the next channel in the queue). A user may find this helpful if he or she is moderately interested in a current channel. For example, if he knows the next channel's score is significantly lower than the current channel's score, he may be less likely to change channels again. However, if he knows the scores for the next two available channels are close to the current channel's score, he may be more inclined to change channels again to see what is available.

In some embodiments, when a channel is selected with a next-up program, the information of the next-up program together with the time to start may be shown on the screen, so that the user knows what to expect in this channel and may plan the surfing accordingly.

In some embodiments, the user may “mark” a channel as a favorite. By marking a channel as a favorite, the calculated score for the channel may be weighted or boosted beyond what it might otherwise be when accounting for the content alone. This may be valuable, for example, if the user believes a channel frequently surprises the user with favorable content that falls outside of her regular viewing habits.

Generally, the techniques disclosed herein may be applied to any system where content is provided, in a live manner, at a designated distribution channel. As used herein, linear TV may be substituted with any linear programming. For example, in an embodiment, the disclosed techniques may be applied to audio applications (e.g., satellite radio, terrestrial radio, and/or IP radio) where, for example, content is provided on channels in a live manner. Metadata about music or radio programs being played such as title, artist, genre, host, start times, stop times, etc. may be included with the respective transmission and utilized to determine recommendations for use with a future channel queue. For example, in some embodiments, a vehicle driver may channel surf local radio stations, satellite radio channels, and live audio streaming channels using buttons on the radio or steering wheel, advancing and going back on channels with a DHCQ and DFCQ.

In some embodiments, the disclosed techniques may be applied to IPTV systems. In the case of IPTV, a channel has a distinct multicast group and set-top boxes (or other devices) join the multicast group to get the stream. For example, a channel may have a distinct multicast group and IPTV devices may join the multicast group to get the stream. Embodiments may utilize, e.g., multicast group addresses for channel navigation (e.g., up and down).

Some embodiments may include VOD services and/or aggregators, which aggregate multiple services, including linear TVs and VOD services, as searching such platforms with thousands of programs available may limit the content that is recommended. Some embodiments may incorporate digital video recorders (e.g., local or remote).

While the disclosed algorithms may typically consider the time left on a show on a specific channel in determining whether the channel should be recommended or not (e.g., when the viewer surfs to a new channel), some embodiments may utilize a “Restart” or “Start Over” mode for some or all channels and/or programs. For instance, a channel may be recommended if the current show that is about to end (e.g., a highly relevant show for the viewer) is available via “Restart” or “Start Over.” In such case, navigating to this channel can present the restart option or automatically plays the “Restart” and/or “on-demand” version of the show (e.g., from that channel or from a recording). Some approaches may check if a program is available on-demand or if there's a recording (e.g., local or remote) in progress for the current program (e.g., live time-shift buffer). A linear TV platform may, e.g., suggest a program and allow the user to go back in the program (e.g., five minutes) or even start the program over (e.g., even if the event has not finished yet).

Some embodiments may allow bookmarking the on-demand program for later viewing as, e.g., the rush may be minimized. Some embodiments may filter out programs that are available on demand. In some embodiments, the content of interest to the user (e.g., when the viewer surfs to a new channel) might be content that was recorded (e.g., new episode of a TV series). For instance, DVR content might be suggested, e.g., when the DVR content is related to current viewed content, predates upcoming desirable content, has advertisements that might be skippable, and/or based on user preferences and behaviors (spending little time before channel changes), etc.

In some embodiments, a channel up/down operation may trigger a modified instance of a channel lineup. For example, if personalized channel surfing is enabled, then the channels (or at least some of the channels) may be temporarily re-ranked in this instance of the lineup. In some embodiments, tuning or channel surfing interfaces can rely on that modified lineup (e.g., temporarily and/or dynamically) instead of the full lineup. In some embodiments, the modified lineup may focus only on recommending channels and content (e.g., not necessarily concerned with the channel history). A dynamic lineup may simply re-score a channel based on user actions (e.g., watching for a period of time, explicit or implicit likes/dislikes, subscription package, watch history, surf history, browse history, time of day, content on the channels, availability of restart option for the content, etc.). Such an approach may not need to maintain two queues. For example, a channel may be changed after seeing an advertisement, but later that channel could still be recommended to the viewer (e.g., as part of the modified instance of the channel lineup) if the content on that channel is highly relevant to the user.

Some embodiments may include an EPG or a TV guide in linear TV, so that when the user is browsing the TV guide, the channel lineup is dynamically changing based on the program at the moment. For instance, some embodiments may have a smart channel surfing visual lineup mode that may indicate which channels are in the queue(s) at the time. Such an embodiment may allow quicker skipping up or down to visually identified channels or programs. Some embodiments may present a smart channel surfing visual lineup.

In some embodiments, a system dynamically scores and rearranges the future queue based on whether the channels are providing commercials. For example, the system may be set to always skip or sometimes skip a channel at the top of the queue if the top channel is currently showing a commercial (e.g., depending on other factors as well, such as what is being provided on other channels, whether the top channel is a favorite channel, or the gap between the top channel and the next best match channel). In some embodiments, when a user changes channels in response to a commercial being shown, the system only changes to channels that are also showing advertisements.

In some embodiments, a linear TV platform may take into account current subscriber entitlements. Some embodiments may include channels that the subscriber is entitled to watch (e.g., subscribed to) in a future queue (e.g., DFCQ). This system may use algorithms that consider all the channels the user can watch. In such an embodiment, channels that are inaccessible to the user based on subscription may be filtered out and not ranked. A subscriber's entitlement information can be shared from a server or headend and can be part of EPG metadata. In some embodiments, if content on a particular channel is being recorded at that particular time, an algorithm may attribute a lower score to such content and/or channel at that point since users are recording the content to consume later. In some embodiments, recorded channels may be “filtered out” of the live queue(s).

In some embodiments, a linear TV platform might use program suggestions in channel surfing as a way to offer and/or recommend channels that are outside of a viewer's current subscription package. An algorithm may identify a channel outside of the subscription (e.g., a premium channel) and prompt the user to subscribe to the channel (or rent/buy the content that is being broadcasted on the channel). For instance, a channel up command can present the user with a channel current showing content that is highly relevant to the user. Some embodiments may give the viewer and/or user a free preview of a channel (e.g., a premium channel and/or PPV event) they do not subscribe to and then prompt the viewer to take an action.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative scenario and user interface for smart channel surfing, in accordance with some embodiments of the disclosure;

FIG. 2 depicts an illustrative scenario and user interface for smart channel surfing, in accordance with some embodiments of the disclosure;

FIG. 3 depicts an illustrative scenario using a dynamic history channel queue, in accordance with some embodiments of the disclosure;

FIG. 4 depicts an illustrative scenario using a dynamic history channel queue and a dynamic future channel queue, in accordance with some embodiments of the disclosure;

FIG. 5A depicts an exemplary initialization structure of a dynamic history channel queue and a dynamic future channel queue, in accordance with some embodiments of the disclosure;

FIG. 5B depicts an illustrative scenario using a dynamic history channel queue and a dynamic future channel queue, in accordance with some embodiments of the disclosure;

FIG. 6 depicts an illustrative flowchart of a process for smart channel surfing, in accordance with some embodiments of the disclosure;

FIG. 7 is a diagram of an illustrative device, in accordance with some embodiments of the disclosure; and

FIG. 8 is a diagram of an illustrative system, in accordance with some embodiments of the disclosure.

### DETAILED DESCRIPTION

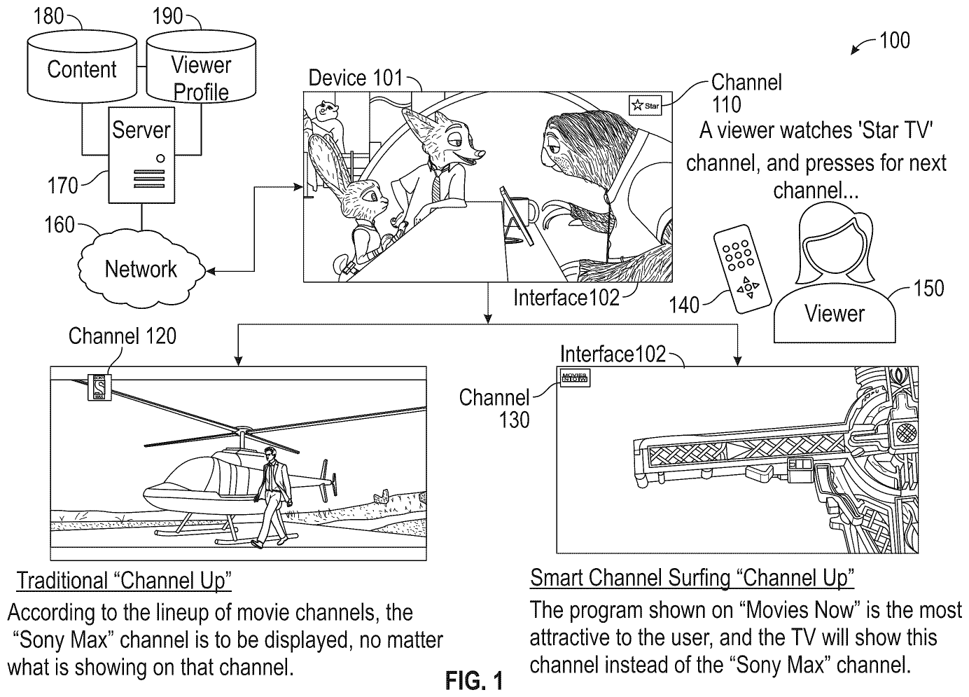

FIG. 1 depicts illustrative scenario 100 and user interfaces for smart channel surfing, in accordance with some embodiments of the disclosure. Scenario 100 of FIG. 1 illustrates an interface 102 of a content delivery system accessible by device 101 via network 160. In scenario 100, device 101 is illustrated as a smart television with interface 102 facilitating channel surfing. By way of a non-limiting example, scenario 100 depicts a channel surfing example. Device 101 is delivered content from content database 180 via server 170 and network 160. Server 170 may access viewer profile database 190, which may store viewer preferences, viewer histories, and recommendations. Viewer 150 may provide input via input device 140. Scenario 100 features channels 110, 120, and 130. For instance, a viewer is watching the Star TV channel 110, and presses for next channel. In the traditional “channel up” scenario, according to the lineup of movie channels, the “Sony Max” channel 120 is to be displayed, no matter what is showing on that channel. In the Smart Channel Surfing scenario “channel up,” the program shown on “Movies Now” channel 130 is the most attractive to the user, and the TV may show this channel instead of the “Sony Max” channel 120.

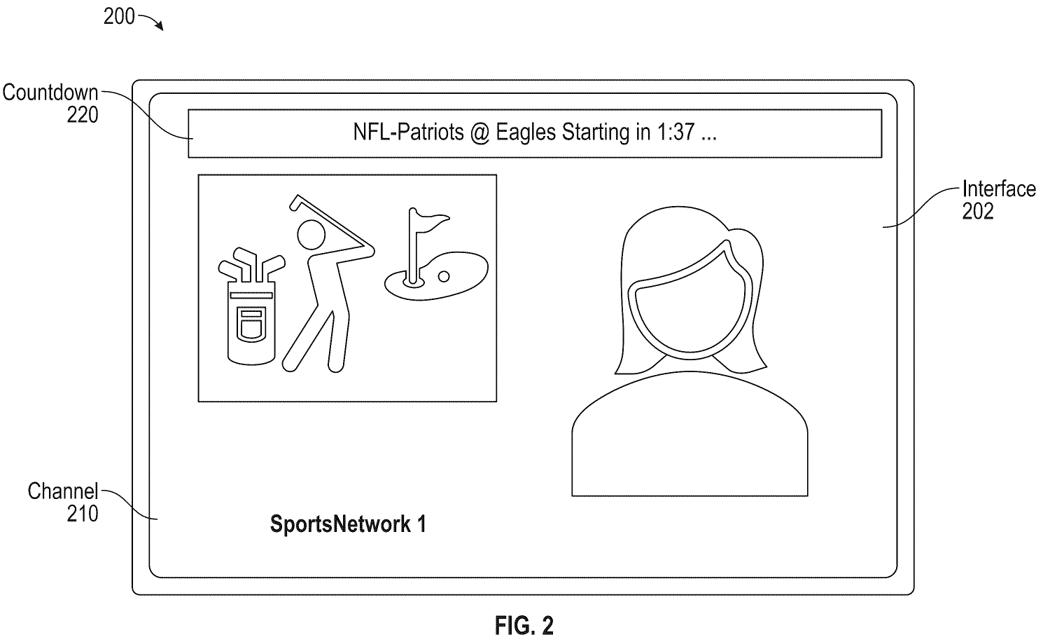

This provides numerous techniques. In an embodiment, a new user experience may be provided, giving users an alternative to existing experiences. For example, one or more disclosed techniques may enable a user to surf to a new channel such that, instead of showing the next channel in the channel list, the channel providing the program that is the most attractive to the user may be shown (e.g., rather than simply incrementing to the next highest channel). Sometimes this “most attractive” or recommended program does not necessarily need to be shown or available right now; it may be a scheduled or “next-up” program for a channel (e.g., it may be determined that showing this channel with some waiting time before the recommended program starts would be the appropriate). In such a case, the system may switch to this new channel, and the program information, including the waiting time, may be shown to the user on the TV screen, as shown in FIG. 2.

Some embodiments may maintain a dynamic queue. Some embodiments may maintain two dynamic queues. In an embodiment, one queue or lineup may be called a Dynamic History Channel Queue (DHCQ), which may dynamically hold the recently browsed channels so the user can surf channels back and forth. In an embodiment, one queue or lineup may be called a Dynamic Future Channel Queue (DFCQ), which may hold the ranked channels of all the other channels that are not in the DHCQ. In some embodiments, the Dynamic History Channel Queue (DHCQ) is different from the video surfing history in the short-video platform, as the DHCQ may be updated dynamically, for example, at a time when the channel in the DHCQ starts a new program. Similarly, according to an embodiment, the DFCQ may be different from the channel lineup in linear TV as it may be dynamically updated based on personalized ranking scores.

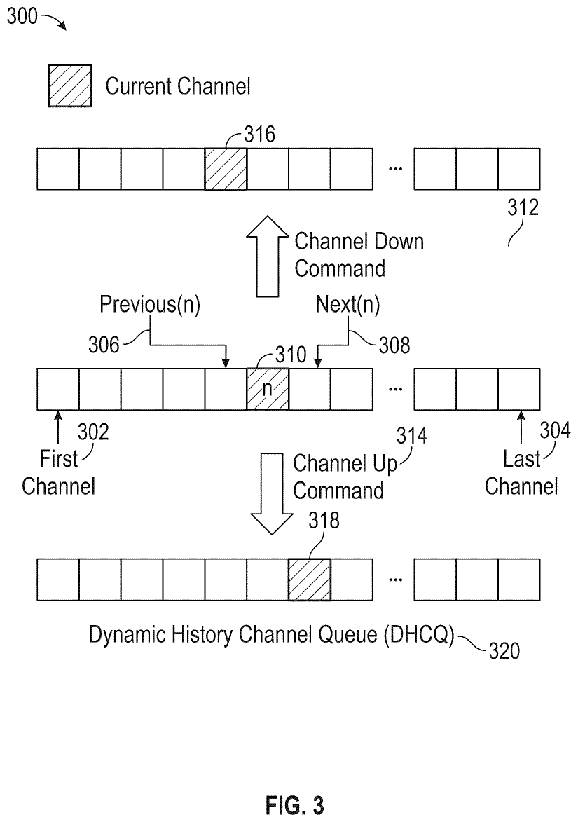

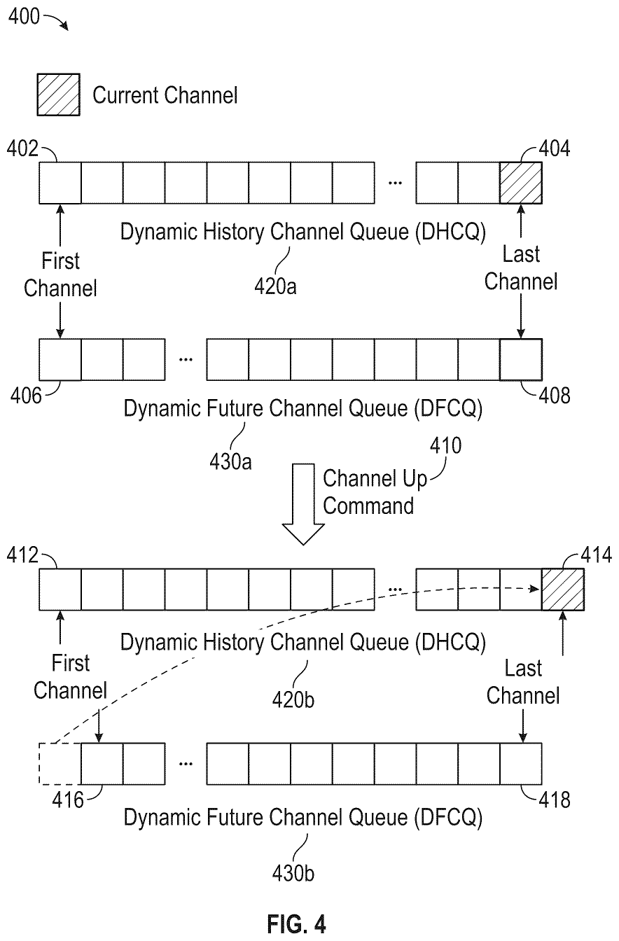

In one example, assume there are M channels available. In this example, the current DHCQ holds N distinguished channels, and DFCQ holds M-N channels. The current channel “n” being watched may be in the DHCQ. When the channel-up is selected, the system does not necessarily switch to channel (n MOD M)+1, as in linear TV. Instead, the system may switch to a channel next(n) in DHCQ if next(n) exists. If n is the last item in the DHCQ, the system may switch to or activate the first channel in DFCQ, and this channel may be removed from DFCQ and appended to DHCQ. In an embodiment, when the user selects the channel-down, the system may switch to previous(n) in the DHCQ, and if channel n is the first item in the DHCQ, it may also optionally switch to the first channel in DFCQ. Some of these operations are illustrated in FIG. 3 and FIG. 4.

In accordance with FIGS. 3-5, the DHCQ and DFCQ may be established and maintained based on a set of rules. In some embodiments, the set of rules may include the following rules. The DHCQ may be initialized as an empty queue, while all the channels at time t=0 are ranked with a ranking algorithm, described later, and these channels are lined up in DFCQ in descending order based on the calculated ranking score, the channel with the highest score is the first channel in DFCQ. This first channel from DFCQ may be then moved from DFCQ to DHCQ, as the current channel in DHCQ. The TV may be initialized in this channel.

In an embodiment, for a pre-defined time interval dT1, some or all the channels in the current DFCQ may be re-ranked and sorted in descending order.

In an embodiment, for each channel in the DHCQ except the current channel being watched, the ending time of the current recommended program may be stored when they are pushed in the DHCQ, and at each of these programs' ending times, the channel may be removed from DHCQ. The new ranking score of this channel may be calculated and this channel may be inserted into DFCQ based on its ranking score.

In an embodiment, for each channel in the current DHCQ, the last visited time of this channel may be recorded. For a pre-defined time interval dT2, if a channel in DHCQ is not visited in past dT2 time period, this channel may be removed from DHCQ. The new ranking score of this channel may be calculated and this channel may be inserted into DFCQ based on its ranking score (e.g., based on time).

In an embodiment, channels in the DHCQ are maintained in the DHCQ for as long as the channels are showing the same programs or content. In an embodiment, a user may backtrack through the DHCQ. In such an embodiment, when the user provides a “next channel” command, the system “crawls” back up through the DHCQ. For example, if the user backtracks through five channels via a “previous channel” command, a “next channel” command causes the system to switch to the fourth skipped channel, then the third skipped channel, etc. After the user crawls back up to the top of the DHCQ, a “next channel” command may cause the system to retrieve a channel from the DFCQ. In an embodiment, when a user backtracks through the DHCQ, skipped channels are added to the DFCQ such that a “next channel” command will always pull from the DFCQ rather than crawling back up through the DHCQ. In an embodiment, when the current channel is the last or top channel in DHCQ (e.g., the most recently visited channel in the DHCQ), and the user selects channel-up or otherwise indicates a desire for a next channel, the first channel in DFCQ may be appended to DHCQ and become the new “last channel,” and the current channel of DHCQ. In an embodiment, if all available channels are in DHCQ and no channel is in DFCQ, and the current channel is the top or last channel (i.e., most recently visited), a “next channel” command may cause the system to change to the first or bottom channel in the DHCQ.

In an embodiment, when the current channel is the first or bottom channel in DHCQ (e.g., the least recently visited channel in the DHCQ), and the user selects channel-down or otherwise indicates a desire for a previous channel, the first channel in DFCQ may be inserted as the new first channel of DHCQ, and as the current channel of DHCQ. In an embodiment, if all available channels are in DHCQ and no channel is in DFCQ and the current channel is the bottom or first channel (i.e., least recently visited), a “next channel” command may cause the system to change to the “last channel” or “top channel” indicated by the DHCQ.

In an embodiment, a logical transition between the two queues occurs in response to interaction with a user interface element (e.g., a physical element such as a button or a software element). In some instances, double tapping a next channel or previous channel user interface element (e.g., button) transitions the user from one queue to the other queue. In an embodiment, a dedicated user interface element exists for transitioning between the two queues.

By way of a non-limiting example, FIG. 3 depicts an illustrative scenario using a dynamic history channel queue. DHCQ 320 contains a plurality of channels including First Channel 302, Previous Channel 306, Current Channel 310, Next Channel 308, and Last Channel 304. Upon receiving Channel Down Command 312, Current Channel 316, corresponding to Previous Channel 306, is played. Upon receiving Channel Up Command 312, Current Channel 318, corresponding to Next Channel 308, is played.

By way of a non-limiting example, FIG. 4 depicts an illustrative scenario using a dynamic history channel queue and a dynamic future channel queue. DHCQ 420a contains a plurality of channels including First Channel 402 and Last Channel 404. DHCQ 430a contains a plurality of channels including First Channel 406 and Last Channel 408. Upon receiving Channel Up Command 410, First Channel 406 of DFCQ 430a is appended to DHCQ 420b as Last Channel 414. First Channel 412 of DHCQ 420b is the same as First Channel 402 of DHCQ 420a. First Channel 416 is established as the first channel in DFCQ 430b. Last Channel 418 of DFCQ 430b is the same as Last Channel 408 of DFCQ 430a.

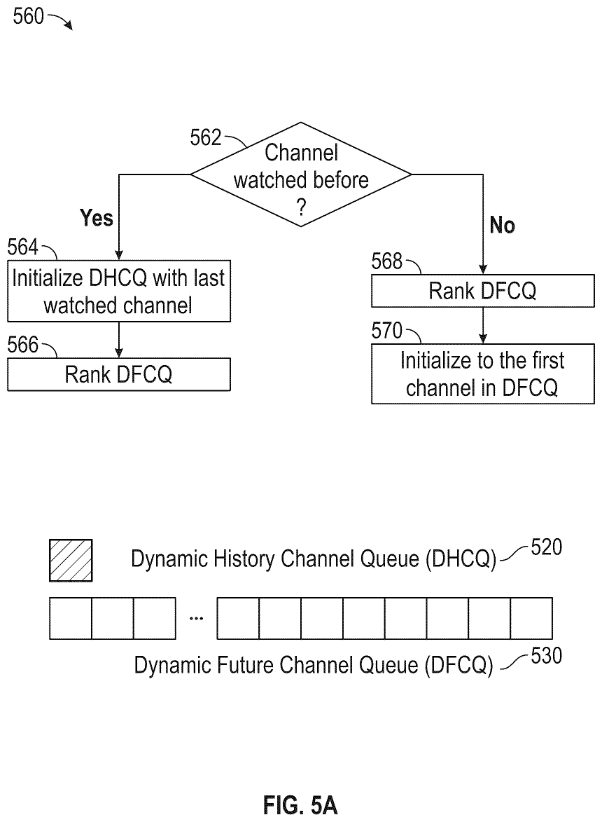

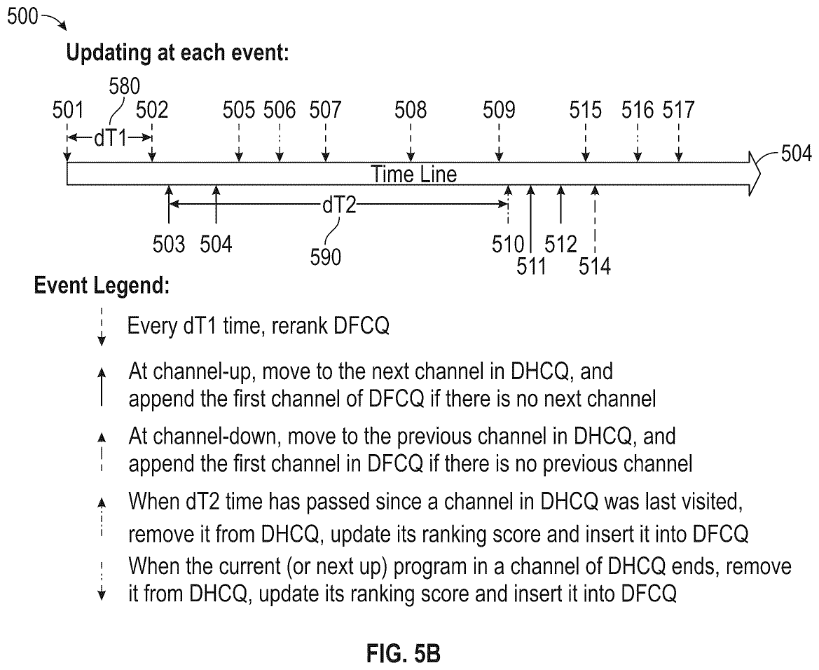

By way of a non-limiting example, FIGS. 5A-B depict, e.g., an initialization and updating structure. FIG. 5A depicts an exemplary initialization procedure (e.g., procedure 560) and structure of a dynamic history channel queue (e.g., DHCQ 520) and a dynamic future channel queue (e.g., DFCQ 530). At step 562, a channel surfing engine determines whether a channel has been watched before. Upon determining that a channel has been watched before, the channel surfing engine proceeds to step 564 where the channel surfing engine initializes DHCQ 520 with the last watched channel. The channel surfing engine then proceeds to step 566, where the channel surfing engine ranks channels to establish DFCQ 530. Upon determining that a channel has not been watched before, the channel surfing engine proceeds to step 568, where it ranks channels to establish DFCQ 510. The channel surfing engine then proceeds to step 570, where it initializes DHCQ 520 with the first channel in DFCQ 530.

FIG. 5B depicts an exemplary updating scenario for a dynamic history channel queue and a dynamic future channel queue. In the specific example timeline 504, shown in scenario 500, at timestamp 501, DHCQ 520 is initialized with a channel, and all the other channels are ranked and put in DFCQ 530 of FIG. 5A. Assume, for example, this channel is the Fox channel and playing “The Simpsons,” and the user starts watching. In an embodiment, after dT1 580 at timestamp 502, and after every preset time period dT1, all the channels in DFCQ 530 get an updated ranking score, and DFCQ 530 is re-ranked based on these new ranking scores.

Staying with the example shown in FIG. 5, at timestamp 503, the arrow with the solid tail indicates the time when the user presses the channel up button when he no longer wants to continue watching “The Simpsons” on the Fox channel. At this time, because there is no next channel in DHCQ, the first channel in DFCQ 530 may be moved into DHCQ 520. Assuming this new channel is the CBS channel playing “Ghosts,” now there are two channels in DHCQ: one is the Fox channel playing The Simpsons, and the other is the CBS channel playing Ghosts, and the current channel is the CBS channel with the Fox channel as the previous channel.

In the shown example, at timestamp 504, the user finds out that the program shown is almost ending and presses the channel up button again, and since there is no next channel in DHCQ 520, the first channel in DFCQ 530 is moved to DHCQ 520. Assume, for example, this channel is the TNT channel playing “Snowpiercer.” Now in DHCQ 520 there are three channels, Fox, CBS, and TNT, with TNT as the current channel. Going along the timeline, all the blue arrows indicate times for DFCQ 530 reranking, including timestamps 505, 507, 508, 509 515, and 517.

At timestamp 506, indicated by the arrow with the tail comprising two dots between two dashes, indicates that one of the previously watched programs in a DHCQ 520 channel ends (e.g., Ghosts on the CBS channel). In this case, the CBS channel may be removed from DHCQ 520, and its ranking score may be recalculated based on its new program, and the CBS channel may be inserted into DFCQ 530 according to its new ranking score. Now the DHCQ 520 may only have two channels, e.g., one is the Fox channel and the other is the TNT channel.

At timestamp 510, a preset time period dT2 590 has passed since the user switched away from the Fox channel. In this example, the Fox channel may be removed from the DHCQ 520 and inserted into DFCQ 530 based on its new ranking score. Now there is only the TNT channel in DHCQ 520. At timestamp 511, the user finds out the “Snowpiercer” program is going to end, and he presses the channel up or otherwise indicates a desire for a next channel. The ranking algorithm may look at the next-up program in each channel when calculating the ranking score. As a result, in this instance, the NBC channel may be the first channel in DFCQ 530 because, for example, the NBC channel will be showing a movie that the user may like in a short time. Therefore, when the user presses the channel up, the system switches to the NBC channel, which is showing NBC news. If desired, the system may provide a notification saying that the movie is going to be aired shortly (e.g., with a countdown). In this example, the system may indicate two channels in DHCQ 520: TNT and NBC.

Since there is still some time in this example, the user may press the channel up or next channel at timestamp 512, which adds the current first channel in DFCQ 530, the Foods channel, into DHCQ 520. At timestamp 514, the user remembers that the movie on NBC is about to start, and he presses the channel down button and comes back to the NBC channel. Now there are three channels in DHCQ 520, TNT, NBC, and Foods, where NBC is the current channel. At timestamp 516, “Snowpiercer” ends in the TNT channel, and the TNT channel is inserted back into DFCQ 530 based on its new ranking score, and there are only two channels left in DHCQ 520, NBC, and Foods, while NBC is the current channel showing the movie.

Generally, personalized ranking and recommendation for linear TV channels may be performed in several ways. In some embodiments, one key parameter is the global timestamp t_global and local timestamp t_local(n), for each channel n, n=1, 2, . . . , M. For a given global timestamp t, the system can obtain the video program v_gt(n) of each channel n, n=1, 2, . . . , M, and can compute the local timestamp of each program as t_local(n).

In an embodiment, for each program v_gt(n), there may be start time t_start and end time t_end, if t_end−t_start is greater than a time period threshold T_th, the system may separate the video into short segments so that each segment has a length less than T_th. For each program v_gt(n), if the program is ending soon, i.e., t_end−t_global is less than a predefined threshold T_th2, the system may also consider the next video program in this channel, v_gt_next(n) and calculate the ranking score of this next video program.

A first deep learning model may be trained to obtain global embeddings F_global from a full video, with features including the title, tags, description, and metadata of the video from a TV guide or other sources. A second deep learning model may be trained to obtain local embeddings F_local for each video segment, using the full video feature together with the feature embedding from the content, including the video frames and text converted from audio and/or captions. A third deep learning model may be trained to obtain a user embedding F_user based on user preference settings, user watching history, and user interaction with the video in the past.

In an embodiment, at a specific global timestamp t_global, each video program under consideration may have two representative video feature embeddings: one is the global embedding F_global, which is computed based on video v_gt(n), and the other is the local embedding F_local, which is calculated from a segment of v_gt(n); this segment contains the local timestamp of t_local(n). For the video program that is not started yet, the system may use set F_local=F_global.

In an embodiment, the system may have two time-based sensitivity measures, one for the video and one for the user. The video genre may determine the video sensitivity S_video, for example, a live sports program might have a different sensitivity from a documentary. The user sensitivity S_user is user-specific and could be manually set by the user. For example, if a user doesn't mind watching from any time point of a program, the sensitivity may be 0; if the user always wants to watch from the beginning, the sensitivity value can be set to 1.

A machine learning model may be trained to obtain a score S_uv_t based on the timestamp t_global, the local timestamp t_local=t_global−t_start, the total length of the video program t_end−t_start, video embeddings F_global, F_local, user embedding F_user, and sensitivity value S_user and S_video, to provide a personalized ranking score of a video program under consideration at timestamp t_global. Please note that the local timestamp for the video is not started, yet can be negative.

In some embodiments, if a channel has two video programs under consideration, the higher-ranking score is used for this channel, and a sorting algorithm may then be able to sort every channel that is under consideration.

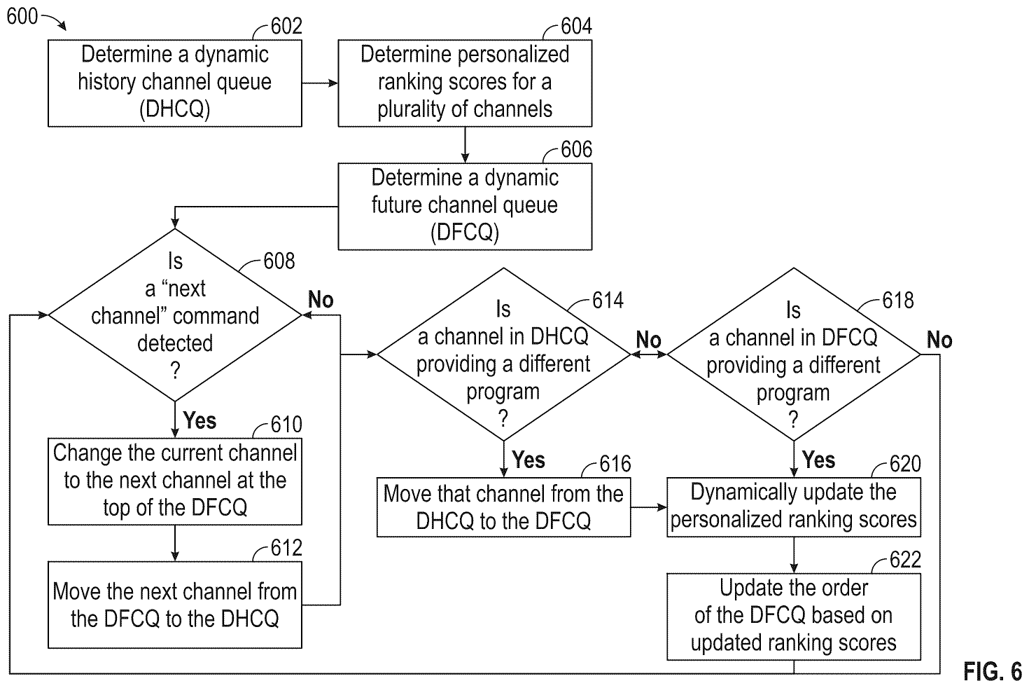

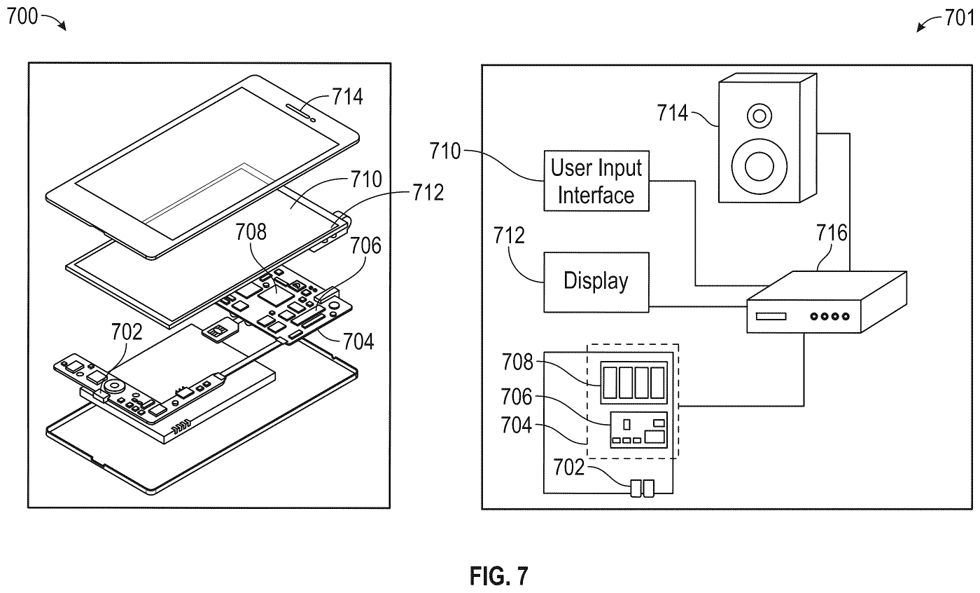

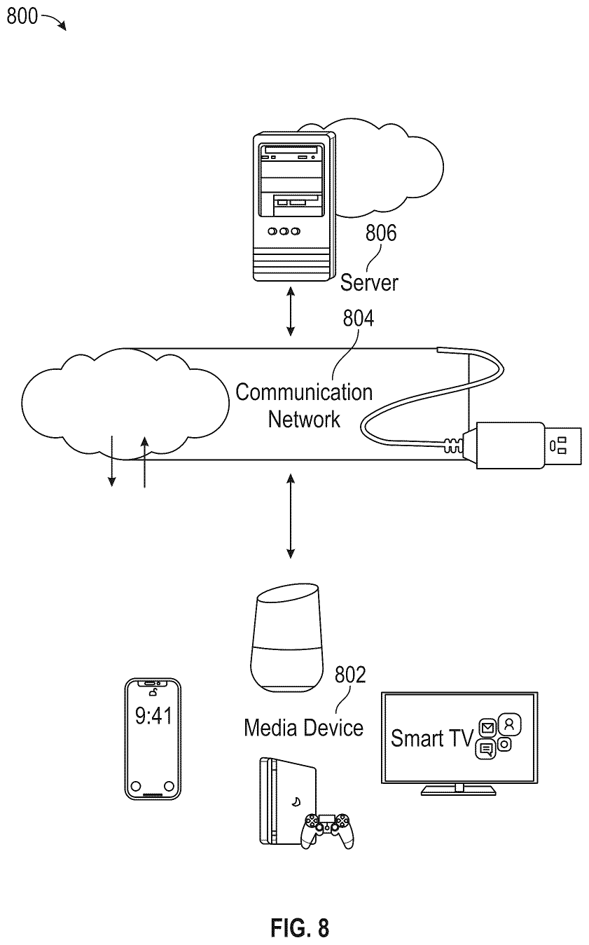

FIG. 6 depicts an illustrative flowchart of a process 600 for smart channel surfing, in accordance with some embodiments of the disclosure. The method 600 may be implemented, in whole or in part, by the device 700 and/or the system 800 shown in FIGS. 7 and 8. One or more actions of the process 600 may be incorporated into or combined with one or more actions of any other process or embodiments described herein (e.g., any one or more actions implemented to enable the scenarios 100-500 shown in FIGS. 1-5). The method 600 may be saved to a memory or storage (such as any one or more of those shown in FIG. 7 or 8) as one or more instructions or routines that may be executed by a corresponding device or system (e.g., device 716, 802, and/or 806) to implement the method 600, in whole or in part. Some embodiments may utilize a channel surfing engine, e.g., as part of an interactive content guidance application, stored and executed by one or more of the processors and memory of a host device, guest device, and/or server.

At step 602, a channel surfing engine determines a history queue (e.g., a DHCQ) indicating a first one or more channels, from a plurality of channels, determined to have been recently viewed, the history queue ordered in a manner that accounts for recency.

At step 604, the channel surfing engine determines personalized ranking scores for a plurality of channels. Determining the personalized ranking scores may include, for instance, (i) detecting content items available on the plurality of channels, (ii) scoring the content items based on a personalized ranking algorithm, and (iii) determining the personalized ranking scores based on the scoring of the content items.

At step 606, the channel surfing engine determines a future queue (e.g., a DFCQ) indicating a second one or more channels, from the plurality of channels, other than the first one or more channels, that are ordered according to the personalized ranking scores for the content available on the second one or more channels.

At step 608, the channel surfing engine detects whether a “next channel” command is input. In response to detecting a “next channel” command is input, the channel surfing engine dynamically updates the history and future queues, including, at step 610, changing the current channel to a given channel at the top of the future queue, and, at step 612, moving the given channel from the future queue to the top of the history queue in response to changing the current channel. If the channel surfing engine detects no “next channel” command is input, then the channel surfing engine continues to monitor.

At step 614, the channel surfing engine determines whether content available on channels in the history queue has changed. In response to detecting content available on channels in the history queue has changed, the channel surfing engine dynamically updates the history and future queues accordingly, including, e.g., at step 616, moving a particular channel from the history queue to the future queue in response to determining that the particular channel is now showing different content than it was when the user last viewed the particular channel. After moving the channel from the DHCQ to the DFCQ, the channel surfing engine dynamically updates, at step 620, the ordering of the future queue. In some embodiments, if a channel in the DFCQ is providing a new/different program (step 618), the channel surfing engine dynamically updates the ordering of the future queue according to a personalized ranking score of the content now available on the particular channel and according to personalized ranking scores of content available on the other channels in the future queue. At step 620, the channel surfing engine dynamically updates the personalized ranking scores and, e.g., at step 622, the channel surfing engine dynamically updates the ordering of the future queue based on the updated ranking scores. If the channel surfing engine detects no content available on channels in the history queue has changed, at step 614, then the channel surfing engine reverts to 608 and continues to monitor.

At step 618, the channel surfing engine determines whether content available on channels in the future queue changes. In response to the channel surfing engine determining that content available on channels in the future queue has changed, at step 620 the channel surfing engine dynamically updates the personalized ranking scores and, at step 622, the channel surfing engine dynamically updates the ordering of the future queue based on the updated ranking scores. If the channel surfing engine detects no content available on channels in the future queue has changed, then the channel surfing engine continues to monitor.

FIG. 7 shows a generalized embodiment of illustrative device 700. In some embodiments, the device 700 may implement, in whole or part, the described channel surfing engine. In some embodiments, the device 700 may implement, in whole or in part, one or more actions to provide the features or user interfaces depicted in FIGS. 1-5. In some embodiments, the device 700 may implement, in whole or in part, the process 600 shown in FIG. 6. As referred to herein, device 700 should be understood to mean any device that can receive input from one or more other devices, one or more network-connected devices, one or more electronic devices having a display, or any device that can provide content for consumption. As depicted in FIG. 7, device 700 is a smartphone, however, device 700 is not limited to smartphones and/or may be any computing device. For example, device 700 of FIG. 7 can be in system 800 of FIG. 8 as device 802, including but not limited to a smartphone, a smart television, a tablet, a microphone (e.g., with voice control or a virtual assistant), a computer, or any combination thereof, for example.

Device 700 may be implemented by a device or system, e.g., a device providing a display to a user, or any other suitable control circuitry configured to generate a display to a user of content. For example, device 700 of FIG. 7 can be implemented as equipment 701. In some embodiments, equipment 701 may include set-top box 716 that includes, or is communicatively coupled to, display 712, audio equipment 714, and user input interface 710. In some embodiments, display 712 may include a television display or a computer display. In some embodiments, user interface input 710 is a remote-control device. Set-top box 716 may include one or more circuit boards. In some embodiments, the one or more circuit boards include processing circuitry, control circuitry, and storage (e.g., RAM, ROM, Hard Disk, Removable Disk, etc.). In some embodiments, circuit boards include an input/output path. Each one of device 700 and equipment 701 may receive content and receive data via input/output (hereinafter “I/O”) path 702. I/O path 702 may provide content and receive data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communication paths (described below). I/O functions may be provided by one or more of these communication paths but are shown as a single path in FIG. 7 to avoid overcomplicating the drawing. While set-top box 716 is shown in FIG. 7 for illustration, any suitable computing device having processing circuitry, control circuitry, and storage may be used in accordance with the present disclosure. For example, set-top box 716 may be replaced by, or complemented by, a personal computer (e.g., a notebook, a laptop, a desktop), a smartphone (e.g., device 700), a tablet, a network-based server hosting a user-accessible client device, a non-user-owned device, any other suitable device, or any combination thereof.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for an application channel surfing engine stored in memory (e.g., storage 708). Specifically, control circuitry 704 may be instructed by the application to perform the functions discussed above and below. For example, the application may provide instructions to control circuitry 704 to generate the content guidance displays. In some implementations, any action performed by control circuitry 704 may be based on instructions received from the application.

In some client/server-based embodiments, control circuitry 704 includes communications circuitry suitable for communicating with an application server. A channel surfing engine may be a stand-alone application implemented on a device or a server. A channel surfing engine may be implemented as software or a set of executable instructions. The instructions for performing any of the embodiments discussed herein of the channel surfing engine may be encoded on non-transitory computer-readable media (e.g., a hard drive, random-access memory on a DRAM integrated circuit, read-only memory on a BLU-RAY disk, etc.) or transitory computer-readable media (e.g., propagating signals carrying data and/or instructions). For example, in FIG. 7, the instructions may be stored in storage 708, and executed by control circuitry 704 of a device 700.

In some embodiments, a channel surfing engine may be a client/server application where only the client application resides on device 700 (e.g., device 802), and a server application resides on an external server (e.g., server 806). For example, a channel surfing engine may be implemented partially as a client application on control circuitry 704 of device 700 and partially on server 806 as a server application running on control circuitry. Server 806 may be a part of a local area network with device 802 or may be part of a cloud computing environment accessed via the internet. In a cloud computing environment, various types of computing services for performing searches on the internet or informational databases, providing storage (e.g., for the keyword-topic database) or parsing data are provided by a collection of network-accessible computing and storage resources (e.g., server 806), referred to as “the cloud.” Device 700 may be a cloud client that relies on the cloud computing capabilities from server 806 to determine times, identify one or more content items, and provide content items by the channel surfing engine. When executed by control circuitry of server 806, the channel surfing engine may instruct the control circuitry to generate the channel surfing engine output (e.g., content items and/or indicators) and transmit the generated output to device 802. The client application may instruct control circuitry of the receiving device 802 to generate the channel surfing engine output. Alternatively, device 802 may perform all computations locally via control circuitry 704 without relying on server 806.

Control circuitry 704 may include communications circuitry suitable for communicating with a channel surfing engine server, a quotation database server, or other networks or servers. The instructions for carrying out the above-mentioned functionality may be stored and executed on the application server 806. Communications circuitry may include a cable modem, an integrated-services digital network (ISDN) modem, a digital subscriber line (DSL) modem, a telephone modem, an ethernet card, or a wireless modem for communications with other equipment, or any other suitable communications circuitry. Such communications may involve the internet or any other suitable communication network or paths. In addition, communications circuitry may include circuitry that enables peer-to-peer communication of devices, or communication of devices in locations remote from each other.

Memory may be an electronic storage device such as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, gaming consoles, gaming media, or any other suitable fixed or removable storage devices, and/or any combination of the same. Storage 708 may be used to store various types of content described herein as well as content guidance data described above. Nonvolatile memory may also be used (e.g., to launch a boot-up routine and other instructions). Cloud-based storage, for example, (e.g., on server 806) may be used to supplement storage 708 or instead of storage 708.

A user may send instructions to control circuitry 704 using user input interface 710. User input interface 710, display 712 may be any suitable interface such as a touchscreen, touchpad, or stylus and/or may be responsive to external device add-ons, such as a remote control, mouse, trackball, keypad, keyboard, joystick, voice recognition interface, or other user input interfaces. Display 712 may include a touchscreen configured to provide a display and receive haptic input. For example, the touchscreen may be configured to receive haptic input from a finger, a stylus, or both. In some embodiments, equipment device 700 may include a front-facing screen and a rear-facing screen, multiple front screens, or multiple angled screens. In some embodiments, user input interface 710 includes a remote-control device having one or more microphones, buttons, keypads, any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top box 716.

Audio equipment 710 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Speakers 714 may be provided as integrated with other elements of each one of device 700 and equipment 701 or may be stand-alone units. An audio component of videos and other content displayed on display 712 may be played through speakers of audio equipment 714. In some embodiments, audio may be distributed to a receiver (not shown), which processes and outputs the audio via speakers of audio equipment 714. In some embodiments, for example, control circuitry 704 is configured to provide audio cues to a user, or other audio feedback to a user, using speakers of audio equipment 714. Audio equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704.

An application (e.g., for generating a display) may be implemented using any suitable architecture. For example, a stand-alone application may be wholly implemented on each one of device 700 and equipment 701. In some such embodiments, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected. An application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 704 may allow a user to provide user profile information or may automatically compile user profile information. For example, control circuitry 704 may monitor the words the user inputs in his/her messages for keywords and topics. In some embodiments, control circuitry 704 monitors user inputs such as texts, calls, conversation audio, social media posts, etc., to detect keywords and topics. Control circuitry 704 may store the detected input terms in a keyword-topic database and the keyword-topic database may be linked to the user profile. Additionally, control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the application is a client/server-based application. Data for use by a thick or thin client implemented on each one of device 700 and equipment 701 is retrieved on-demand by issuing requests to a server remote from each one of device 700 and equipment 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding displays. For example, device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to device 700 for presentation to the user.

As depicted in FIG. 8, a system 800 may include a device 802, which may be coupled to communication network 804. In some embodiments, the device 800 may implement, in whole or part, the described channel surfing engine. In some embodiments, the system 800 may implement, in whole or in part, one or more actions to provide the features or user interfaces depicted in FIGS. 1-5. In some embodiments, the system 800 may implement, in whole or in part, the process 600 shown in FIG. 6. Communication network 804 may be one or more networks including the internet, a mobile phone network, mobile voice or data network (e.g., a 4G or LTE network), cable network, public switched telephone network, Bluetooth, or other types of communication network or combinations of communication networks. Thus, device 802 may communicate with server 806 over communication network 804 via communications circuitry described above. In should be noted that there may be more than one server 806, but only one is shown in FIG. 8 to avoid overcomplicating the drawing. The arrows connecting the respective device(s) and server(s) represent communication paths, which may include a satellite path, a fiber-optic path, a cable path, a path that supports internet communications (e.g., IPTV), free-space connections (e.g., for broadcast or other wireless signals), or any other suitable wired or wireless communications path or combination of such paths.

In some embodiments, the application is downloaded and interpreted or otherwise run by an interpreter or virtual machine (e.g., run by control circuitry 704). In some embodiments, the application may be encoded in the ETV Binary Interchange Format (EBIF), received by control circuitry 704 as part of a suitable feed, and interpreted by a user agent running on control circuitry 704. For example, the application may be an EBIF application. In some embodiments, the application may be defined by a series of JAVA-based files that are received and run by a local virtual machine or other suitable middleware executed by control circuitry 704.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
generating for display a first content item of a first channel;
determining a personalized ranking score for each channel of a plurality of channels;
determining a dynamic future channel queue (DFCQ) comprising one or more unviewed channels wherein the one or more unviewed channels are ordered in the DFCQ based on the respective personalized ranking score of each unviewed channel;
receiving a command to display a next channel; and
generating for display a second content item of the next channel wherein the next channel is selected from the DFCQ based on the order of the DFCQ.

2. The method of claim 1, further comprising:
determining a dynamic history channel queue (DHCQ) comprising one or more recently viewed channels wherein the one or more recently viewed channels are ordered in the DHCQ based at least in part on recency and wherein the first channel is in a first position in the DHCQ;
removing the next channel from the DFCQ;
moving the next channel to the first position in the DHCQ; and
moving the first channel to a second position in the DHCQ.

3. The method of claim 2, further comprising:
determining that the first content item is no longer present on the first channel; and
based at least in part on determining that the first content item is no longer present on the first channel:
removing the first channel from the DHCQ;
determining a first personalized ranking score for the first channel; and
adding the first channel to the DFCQ in a position based on the first personalized ranking score.

4. The method of claim 1, wherein the determining the personalized ranking score for each channel of the plurality of channels comprises:
detecting a plurality of content items available on each channel of the plurality of channels;
scoring each content item of the plurality of content items based on a personalized ranking algorithm; and
determining the personalized ranking score for each channel based on the scoring of the respective content item of the plurality of content items.

5. The method of claim 4, wherein the scoring each content item of the plurality of content items based at least in part on the personalized ranking algorithm comprises determining a time remaining for each content item of the plurality of content items.

6. The method of claim 1, further comprising:
determining that a predetermined length of time has passed since the personalized ranking score for each channel of the plurality of channels was determined; and
after determining that the predetermined length of time has passed:
determining an updated personalized ranking score for each channel of the plurality of channels; and
determining an updated order of the unviewed channels in the DFCQ based on the updated personalized ranking scores.

7. The method of claim 2, further comprising:
receiving a command to display a previous channel; and
generating for display the second content item of the next channel based on the next channel currently being in the first position in the DHCQ.

8. The method of claim 7, further comprising:
receiving a command to display a next previous channel; and
generating for display the first content item of the first channel based on the first channel currently being in the first position in the DHCQ.

9. The method of claim 2, further comprising:
determining that a predetermined length of time has passed since the first channel was last viewed;
after determining that the predetermined length of time has passed:
removing the first channel from the DHCQ;
determining a first personalized ranking score for the first channel; and
adding the first channel to the DFCQ in a position based on the first personalized ranking score.

10. The method of claim 1, wherein the generating for display the second content item of the next channel comprises providing for display a picture-in-picture preview.

11. A system comprising:
memory;
control circuitry configured to:
generate for display a first content item of a first channel;
determine a personalized ranking score for each channel of a plurality of channels;
determine a dynamic future channel queue (DFCQ), stored in the memory, comprising one or more unviewed channels wherein the one or more unviewed channels are ordered in the DFCQ based on the respective personalized ranking score of each unviewed channel;
receive a command to display a next channel; and
generate for display a second content item of the next channel wherein the next channel is selected from the DFCQ based on the order of the DFCQ.

12. The system of claim 11, the control circuitry further configured to:
determine a dynamic history channel queue (DHCQ) comprising one or more recently viewed channels wherein the one or more recently viewed channels are ordered in the DHCQ based at least in part on recency and wherein the first channel is in a first position in the DHCQ;
remove the next channel from the DFCQ;
move the next channel to the first position in the DHCQ; and
move the first channel to a second position in the DHCQ.

13. The system of claim 12, the control circuitry further configured to:
determine that the first content item is no longer present on the first channel; and
based at least in part on determining that the first content item is no longer present on the first channel:
remove the first channel from the DHCQ;
determine a first personalized ranking score for the first channel; and
add the first channel to the DFCQ in a position based on the first personalized ranking score.

14. The system of claim 11, wherein the control circuitry is configured to determine the personalized ranking score for each channel of the plurality of channels by:
detecting a plurality of content items available on each channel of the plurality of channels;
scoring each content item of the plurality of content items based on a personalized ranking algorithm; and
determining the personalized ranking score for each channel based on the scoring of the respective content item of the plurality of content items.

15. The system of claim 14, wherein the control circuitry is configured to score each content item of the plurality of content items based at least in part on the personalized ranking algorithm comprises determining a time remaining for each content item of the plurality of content items.

16. The system of claim 11, the control circuitry further configured to:
determine that a predetermined length of time has passed since the personalized ranking score for each channel of the plurality of channels was determined; and
after determining that the predetermined length of time has passed:
determine an updated personalized ranking score for each channel of the plurality of channels; and
determine an updated order of the unviewed channels in the DFCQ based on the updated personalized ranking scores.

17. The system of claim 12, the control circuitry further configured to:
receive a command to display a previous channel; and
generate for display the second content item of the next channel based on the next channel currently being in the first position in the DHCQ.

18. The system of claim 17, the control circuitry further configured to:
receive a command to display a next previous channel; and
generate for display the first content item of the first channel based on the first channel currently being in the first position in the DHCQ.

19. The system of claim 12, the control circuitry further configured to:
determine that a predetermined length of time has passed since the first channel was last viewed;
after determining that the predetermined length of time has passed:
removing the first channel from the DHCQ;
determining a first personalized ranking score for the first channel; and
adding the first channel to the DFCQ in a position based on the first personalized ranking score.

20. A method comprising:
generating for display video content of a first content item of a first channel wherein the first channel is in a second position in a dynamic history channel queue (DHCQ), wherein the DHCQ comprises channels that are presenting previously viewed content items;
determining a dynamic future channel queue (DFCQ) comprising one or more unviewed channels wherein the one or more unviewed channels are ordered in the DFCQ based on respective personalized ranking scores of each unviewed channel;
receiving a command to display a next channel;
generating for display a second content item of the next channel wherein the next channel is in a first position in the DHCQ;
receiving a command to display a second next channel; and
generating for display a third content item of the second next channel wherein the second next channel is selected from the DFCQ based on the order of the DFCQ.

21-50. (canceled)
